(19) United States
(12) Patent Application Publication
(10) Pub. No.: US 2020/0238322 A1
(43) Pub. Date: Jul. 30, 2020

(54) METHOD FOR MONITORING AND/OR MODIFYING AN ACTIVE AGENT CONCENTRATION IN A SPRAY LIQUID OF A SPRAY DEVICE

(71) Applicant: Robert Bosch GmbH, Stuttgart (DE)

(72) Inventors: Bernd Stuke, Leonberg (DE); Helmut Schomburg, Deufringen (DE); Olaf Ohlhafer, Erligheim (DE); Steffen Sies, Rottenburg (DE); Hans-Arndt Freudigmann, Tuebingen (DE)

(21) Appl. No.: 16/755,971

(22) PCT Filed: Oct. 19, 2018
(86) PCT No.: PCT/EP2018/078757

§ 371 Date: Apr. 14, 2020

(30) Foreign Application Priority Data
Nov. 10, 2017 (DE) 10 2017 220 006.5

(51) Int. Cl. B05B 12/08; B05B 7/32; B05B 9/04; B05B 15/25; A01C 23/00; A01M 7/00

(52) U.S. Cl. CPC B05B 12/08; B05B 7/32; A01M 7/0092; B05B 15/25; A01C 23/007; B05B 9/0423

(57) ABSTRACT

A method for monitoring and/or modifying an active agent concentration in a spray liquid of a spray device including a plurality of spray nozzle units for deploying the spray liquid for agricultural purposes. The method includes receiving one property signal each including a piece of property information of the spray liquid detected with the aid of a sensor unit of the spray device in a through-flow area of one each of the spray nozzle units, an active agent concentration in the spray liquid being ascertainable using the piece of property information; and outputting an information signal to a display unit and/or a control signal to an intermixing unit and/or a delivery unit of the spray device as a function of the received piece of property information of the spray liquid and/or of an active agent concentration in the spray liquid ascertained using the piece of property information.

### FIELD

The present invention relates to a method for monitoring and/or modifying an active agent concentration in a spray liquid of a spray device, including a plurality of spray nozzle units for deploying the spray liquid, in particular, for agricultural purposes.

### BACKGROUND INFORMATION

In conventional methods controlling nozzles, the spray cones of each individual nozzle is visually controlled by the farmer during the application via an LED single nozzle illumination.

German Patent Application No. DE 10 2011 052 030 A1 describes a method for automatically monitoring a flow through a nozzle unit with the aid of a thermal flow monitoring sensor for controlling the functionality of the nozzles on field sprayers.

German Patent Application No. DE 10 2009 026 234 A1 describes a field sprayer including sensors for ascertaining and adjusting an active agent concentration in a spray liquid.

### SUMMARY

In accordance with an example embodiment of the present invention, a method is provided for monitoring and/or modifying an active agent concentration in a spray liquid of a spray device including a plurality of spray nozzle units for deploying the spray liquid, in particular, for agricultural purposes, including the steps:
receiving one property signal each including a piece of property information of the spray liquid detected with the aid of a sensor unit of the spray device in a through-flow area units respectively, an active agent concentration in the spray liquid being ascertainable using the property information; and
outputting an information signal to a display unit and/or a control signal to an intermixing unit and/or to a delivery unit of the spray device as a function of the received property information of the spray liquid and/or of an active agent concentration in the spray liquid ascertained using the property information, in order to monitor and/or to modify the active agent concentration in the spray liquid in the spray nozzle units.

In accordance with an example embodiment of the present invention, a control unit is provided, which is configured to carry out all steps of a previously described method.

The present invention also provided an example spray device including a plurality of spray nozzle units for deploying a spray liquid that includes an active agent, in particular, for agricultural purposes, including:
an intermixing unit for intermixing the spray liquid and/or a delivery unit for adjusting an active agent concentration in the spray liquid;
sensor units for detecting one piece of property information each of the spray liquid in a through-flow area of one each of the spray nozzle units, an active agent concentration in the spray liquid being ascertainable using the property information; and
a previously described control unit for monitoring and/or for modifying the active agent concentration in the spray nozzle unit.

The present invention also provides an example computer program, which is configured to carry out all steps of a previously described method, as well as an example machine-readable memory medium on which the computer program is stored.

An agricultural purpose is understood within the scope of the present invention to mean a purpose, which is directed to an economic cultivation of crop plants.

The spray device may, in particular, be part of an agricultural field sprayer or a plant protection device, or may be designed as an agricultural field sprayer or a plant protection device. The spray device may be attachable and/or attached on or at a mobile unit. The mobile unit may be designed as a farm vehicle and/or as an aircraft and/or as a trailer. The mobile unit may, in particular, be an agricultural machine, for example, a truck, a tractor or a (self-propelled or autonomous) field sprayer. The spray device may also be attached to a hydraulic device of the agricultural machine. It is also possible that the spray device is built on a loading platform of the agricultural machine. Alternatively, the spray device may be coupled to the agricultural work machine.

The spray liquid in this case is preferably deployed on a field. A field in the present case may be understood to mean an agricultural area or an area utilized for agriculture, a cultivation acreage for plants or also a parcel of such an area or crop area. The field may thus be arable land, grassland or pasture land. The plants may include crop plants, for example, whose yield is utilized agriculturally (for example, as foodstuff, animal feed or as energy crop), as well as waste plants, weeds and grass weeds. The plants may be part of the agricultural area.

The term “spray liquid” within the scope of the present invention includes both the entire spray liquid as well as only a portion or fraction, in particular, a spatially limited portion or fraction of the spray liquid in the spray device. The spatially limited portion or fraction of the spray liquid may, for example, be the portion of spray liquid situated in a spray nozzle unit.

The spray liquid includes at least one active agent. However, the spray liquid may also include two or multiple active agents. The active agent may include a “spraying agent”, i.e., a preparation or plant protection agent, in particular, a plant protection agent concentrate. Accordingly, the active agent may, for example, include an herbicide, fungicide or an insecticide (pesticide). The spray liquid may be a spray mixture. However, the active agent may also be a fertilizer, in particular, a fertilizer concentrate. Accordingly, the active agent may include a liquid fertilizer and/or a growth regulator. The active agent may be formed as a liquid or as a solid, for example, in the form of granulates or as a pre-dissolved solid, for example, in the form of pre-dissolved granulates.

The spray liquid preferably further includes a liquid, in particular, a carrier liquid for diluting the active agent. A carrier liquid may be understood within the scope of the present invention to mean a liquid, which is designed to be intermixed with the active agent in order to enable or improve a deployment or delivery of the active agent, for example, of the plant protection agent or of the fertilizer. It is also possible that an active agent is suspended as a solid or a granulate in the carrier liquid. It is further possible that a non-soluble active agent in the carrier liquid is emulsified in the carrier liquid. The carrier liquid is preferably water.

Accordingly, the spray liquid may be formed as: a liquid, suspension, emulsion, solution or a combination thereof. The spray liquid is designed preferably as a plant protection agent diluted with water or a fertilizer diluted with water.

The spray device includes a spray liquid tank for accommodating the spray liquid and at least one spray nozzle unit for deploying the spray liquid. The spray liquid may be fed or conducted from the spray liquid tank to the spray nozzle unit with the aid of a spray liquid line or multiple spray liquid lines. A line or spray liquid line may be understood within the scope of the present invention to also mean a section of the corresponding line or of the spray liquid line. The line may be designed as fluidic connection line, for example, in the form of a pipe, hose, duct or a tube.

The spray liquid may be poured pre-blended into the spray liquid tank of the spray device. The spray liquid may, however, also first be blended in the spray device. To blend the spray liquid, the spray device may include (in the flow direction of the spray liquid) a mixing unit upstream from the spray liquid tank, into which the liquid is fed or conducted from a liquid tank of the spray device, and the active agent from an active agent tank of the spray device. In this case a liquid delivery unit may be provided, which is designed to conduct or deliver the liquid from the liquid tank via a liquid line to the mixing unit in a targeted or defined manner. An active agent delivery unit may also be provided, which is designed to conduct or deliver the active agent from the active agent tank via an active agent line to the mixing unit in a targeted or defined or metered manner. The delivery units may include one or multiple metering units or metering components. The metering units or metering components may include one or multiple pumps or metering pumps and valves. At least one of the delivery units may be designed to generate the spray pressure at the spray nozzle unit, i.e. the pressure with which the spray liquid is deployed.

A mixing unit may be understood within the scope of the present invention to mean a unit, which is designed to intermix or blend, preferably as homogenously as possible, at least the liquid and the active agent with one another to form the spray liquid. The mixing unit may include a mixing element or agitator element, in order to actively intermix the liquid and the active agent with one another. The agitator element may be designed as an agitator blade or a propeller. The mixing unit may include a mixing tank including at least one inlet each for the liquid and for the active agent. This means in another words that the liquid and the active agent may be fed separately, i.e., with the aid of separate lines, directly into the mixing unit or mixing tank. Alternatively, a shared inlet may be provided at the mixing unit in the form of a T-piece, the active agent being initially fed to the liquid or introduced into the liquid and subsequently fed together with the liquid into the mixing unit. The mixing unit or the mixing tank may include at least one outlet for the intermixed or blended spray liquid, for example, in a lower area. It is also possible that the mixing unit is designed as a static mixing unit or static mixer. The mixing unit may, however, also be designed only as a T-piece, so that a passive intermixing takes place in the mixing unit.

The mixing unit may also be integrated into the spray liquid tank. Accordingly, the spray liquid tank may be designed as a mixing tank of the mixing unit. The mixing element and/or agitator element in this case may be situated on or in the spray liquid tank, in order to intermix or blend the spray liquid.

The spray liquid tank may, however, also be situated in the spray liquid line downstream from the mixing unit. This means in other words that the spray liquid tank is situated in the flow direction of the spray liquid from the mixing unit to the spray nozzle unit behind or after the mixing unit. The spray liquid tank may thus be spatially situated in the spray liquid line between the mixing unit and the spray nozzle unit. The spray liquid tank may be designed as a buffer tank, so that the spray liquid is feedable or fillable from the mixing unit initially into the buffer tank and feedable or deliverable or conductable from the buffer tank to the spray nozzle unit as needed.

The spray device may also include a spray liquid delivery unit, which is situated in, and/or is integrated into, the spray liquid line downstream from the spray liquid tank or buffer tank. The spray liquid delivery unit may then be designed to conduct the spray liquid from the spray liquid tank or buffer tank under pressure or under a defined pressure to the spray nozzles or spray nozzle units. The spray liquid delivery unit may be designed, in particular, to generate a constant pressure, i.e. may be designed as a constant pressure system, in order to generate a constant or uniform spray pressure at the spray nozzles or spray nozzle units. Since the defined spray pressure is generated by the spray liquid delivery unit, the delivery units upstream from the buffer tank, i.e., the liquid delivery units and the active agent delivery unit, may be very simply designed, since they need only assume the task of feeding the liquid or the active agent into the buffer tank.

If the spray liquid delivery unit is integrated into the buffer tank, the buffer tank may be designed as a pressure accumulator, for example, including media demixing (spray liquid—air). The pressure regulation in the buffer tank may then take place via a pneumatic pressure regulating valve, so that potential pressure fluctuations in the system may be reduced. The spray liquid delivery unit is preferably, however, situated downstream from the spray liquid tank, as a result of which the buffer tank may be designed to be pressureless. In this case the buffer tank may be designed to be pressureless, for example, with the aid of a ventilation hole. The ventilation hole may include a ventilation valve. This means in other words that the buffer tank is fluidically connected to the surroundings, or is connectable at a defined internal pressure, so that it is designed to be pressureless. With this measure, the liquid delivery unit and the active agent delivery unit need preferably no longer operate against the high system pressure but merely against the ambient pressure (and the counter pressure occurring due to losses of flow), so that the pressure requirements of the corresponding pumps or metering pumps are further reduced. The liquid delivery unit may, for example, include a simple flow pump or delivery pump, which has a pure in/out functionality. The required metered volume flow of the active agent may then be ascertained and the active agent metering pump may be activated via the volume flow signal and the previously adjusted mixing ratio in connection with a volumetric flow meter. Alternatively, the liquid delivery unit may include a metering pump having a fixed conveying ratio (without measurement of the delivery volume). It is also possible that the liquid delivery unit includes a simple valve or a proportional valve in connection with a volumetric flow meter and a constant pressure source in the liquid line. It is also possible that the liquid delivery unit includes a constant pressure source and a metering aperture. As an alternative to the metering pump, the active agent delivery unit may include a simple delivery pump in connection with a volumetric flow meter (regulation). The active agent delivery unit in this case may additionally include at least one metering aperture. The buffer storage may also be designed very simply and generally with no static requirements, as a result of which the overall costs may be further reduced.

The spray nozzle unit includes in each case at least one spray nozzle for deploying the spray liquid and at least one valve for controlling or regulating the deployed quantity of spray liquid. Accordingly, the spray nozzle unit is controllable or actuatable, i.e., designed to be openable and closable. Each of the spray nozzle units is preferably separately activatable, in particular, as a function of the property information in the associated through-flow area. The valve may be situated in or integrated into the spray nozzle. The valve may, however, also be situated in front of the spray nozzle, i.e., (in the flow direction of the spray liquid) upstream from the spray nozzle. The spray nozzle unit may, however, also include multiple spray nozzles, each including an upstream valve. The spray nozzle unit may further also include multiple spray nozzles including only one valve upstream from the spray nozzles, so that when actuating the valve, the spray liquid is deployed with the aid of all spray nozzles of the spray nozzle unit. Accordingly, the spray nozzle unit may be designed as a part-width section of a nozzle system. The spray nozzle unit may also include a final mixing unit, which is designed to intermix the spray liquid with the liquid and or with the active agent and/or with an additional active agent—which are conductable or feedable with the aid of corresponding lines to the final mixing unit. In this case, it is advantageous to provide a combination of the final mixing unit and the previously described mixing unit, which in this case would be designed as a pre-mixing unit, in order to obtain a two-stage mixing system.

The through-flow area of the spray nozzle unit, in which the property information of the spray liquid is detected, is an area through which spray liquid is flowable. Accordingly, this is an area, which comes into contact with the spray liquid, in particular, during the deployment process of the spray liquid. The through-flow area is preferably situated in at least one component, which is selected from the group made up of: spray nozzle, valve, spray liquid line of the spray liquid unit. The through-flow area may include a section of an interior space or the interior space as a whole of the corresponding component. The through-flow area is preferably situated in or directly in front of the spray nozzle or spray nozzles.

The sensor unit may include a sensor element or a sensor or also multiple sensor elements or sensors. The sensor unit may be situated in the through-flow area. The sensor unit in this case may be in direct contact with the spray liquid in order to detect the property information of the spray liquid. The sensor unit may, however, also be situated outside the through-flow area. The sensor unit in this case may be designed to detect the property information of the spray liquid in a contactless manner. In addition to the property information, the sensor unit may be designed to detect a temperature of the spray liquid in the through-flow area. The sensor unit may include a transmission unit. The transmission unit may be designed to transmit or to send the property signal including the detected values or measured values of the property information wirelessly, for example, via radio, WLAN, Bluetooth, etc., and/or in a hardwired manner.

The property signal includes a detected piece of property information and a detected value/measured value of the property information. In this case, one spray nozzle unit each or each of the spray nozzle units will receive one property signal each. Each of the property signals in turn includes one piece of property information respectively of the corresponding spray liquid or of the corresponding spray liquid fraction from the respective spray nozzle unit. An active agent concentration in the spray liquid is ascertainable using the detected property information or the detected value of the property information. This means in other words that an active agent concentration in the spray liquid is (directly or indirectly) derivable from the property information. In particular, the property information of the spray liquid and the active agent concentration in the spray liquid are generally uniquely a function of one another. The property information of the spray liquid and the active agent concentration in the spray liquid in this case may be a linear function of one another. Accordingly, it is possible to deduce the active agent concentration in the spray liquid with the aid of the detected property information and the detected value of the property information. The property information may be a physical and/or chemical and/or bodily and/or material property of the spray liquid. The detected property information is preferably selected from the group made up of: electrical property, in particular, electrical conductivity or permittivity, visual property, in particular, absorption property, emission property, fluorescence, sound velocity, or a combination thereof. In this way, it is possible with the aid of computing methods known to those skilled in the art to very easily ascertain an active agent concentration in the spray liquid. The detected property information is preferably an electrical conductivity. The detected property information further preferably includes a volume flow of the spray liquid, so that a quantity of the deployed spray liquid is ascertainable.

Thus, for example, the electrical conductivity of a solution is a universal physical variable and indicates the ability of a material to conduct an electrical current. This conductivity is strongly a function of the quantity of dissolved salts, which are to be found either already in the active agents or the spraying agents, or which could also be added to the active agent by the manufacturers or the farmers. Other physically measurable material variables, in addition to conductivity, may also be utilized for determining the concentration of the active agent. Thus, the clouding of the solution (and thus the absorption coefficient for light) also changes with the concentration of the active agent in water due to the proportion of undissolved particles in the solution, or also the sound velocity (in particular, as a function of the density and compressibility of the medium). There is also the possibility of deducing the concentration of the active agent, for example, via fluorescence measurements. Here, a type of tracer (for example, a dye) could also be added to the active agents.

The steps of receiving the property signal and of outputting the information signal and/or the control signal may be carried out with the aid of a control unit. The ascertainment or calculation of the active agent concentration in the spray liquid may also be carried out with the aid of the control unit and of computing methods known to those skilled in the art. A control unit in the present case may be understood to mean an electrical device, which processes sensor signals and outputs control signals and/or information signals/data signals as a function thereof. For this purpose, the control unit may include at least one processing unit for processing the property signals or pieces of property information. The processing unit may, for example, be a signal processor, a microcontroller or the like. The control unit may further include at least one memory unit for storing the property signals or pieces of property information or may be connected for this purpose to a memory unit. The memory unit may include a cloud server, a flash memory, an EPROM or a magnetic memory unit. The control unit may also include at least one communication interface for reading in the property signals and for outputting the information signals and/or the control signals. The communication interface may be designed to read in or output the signals wirelessly, for example, via radio, WLAN, Bluetooth, etc., and/or in a hardwired manner. The communication interface may be designed in hardware and/or in software. In a hardware design, the interface may, for example, be part of a so-called system ASIC, which contains a wide variety of functions of the control unit. It is also possible, however, for the interface to include dedicated integrated circuits or to be made at least partly of discrete components. In a software design, the interface may be a software module, which is present, for example, on a microcontroller alongside other software modules. The step of outputting takes place as a function of the property signal or of the received property information of the spray liquid and/or of an active agent concentration in the spray liquid ascertained using the property information. This means in other words that it is decided as a function of the property information or of the detected value of the property information and/or of the active agent concentration or of the ascertained value of the active agent concentration whether a signal and/or what type of signal, if necessary, also including which content, is output.

In this case, a step of comparing the values of the pieces of property information and/or the active agent concentrations in the spray liquid with a predefinable reference value and/or a predefinable reference value range of the property information and/or of the active agent concentration is carried out, in order as a function thereof, to output the information signal to the display unit and/or the control signal to the intermixing unit and/or to the delivery unit. It is further advantageous if alternatively or in addition, a step of comparing the reference gradient values of the pieces of property information and/or of active agent concentrations in the spray liquid with a predefinable reference gradient of the property information and/or of the active agent concentration is provided, in order as a function thereof to output the information signal to the display unit and/or the control signal to the intermixing unit and/or to the delivery unit. The term “predefinable” within the scope of this invention also encompasses the term “predefined”. The step of comparing values within the scope of this invention further includes a comparison of a curve of values. It may in turn then be decided as a function of the comparison whether a signal is output and, if necessary, which type of signal, i.e., including which content. The information signal is output preferably to the display unit and/or the control signal is preferably output to the intermixing unit if at least the value of a piece of property information and/or of an active agent concentration in the spray liquid reaches the reference value and/or the reference value range and/or reference gradient value and/or with a defined deviation thereof. The reference values and/or the reference gradient value may, in particular, be input manually, calculated and/or read out from a table. The reference value and/or the reference value range and/or the reference gradient value is/are a function, in particular, of the active agent. For example, the information signal and/or the control signal could be output with a deviation of 1% of the average value of the values of the property information. The step of comparing may be carried out with the aid of the processing unit of the control unit.

The change of the active agent concentration includes both a change of the concentration value as well as a change of the concentration distribution in the spray liquid. This involves a defined change of the concentration value or a defined change of the concentration distribution.

The intermixing unit is designed to carry out an intermixing process in the spray liquid. An intermixing process may be understood within the scope of the present invention to be an intermixing or a blending of the spray liquid in a through-flow area, in particular, in the spray liquid tank and in the lines, in order to obtain a generally homogenous distribution of the active agent concentration in the spray liquid. The intermixing process may be implementable for a defined or predefined duration, i.e., may automatically stop after a defined or predefined duration. The intermixing unit is designed to intermix the spray liquid with the aid of a circulation line and/or of an agitator element situated in a spray liquid tank of the spray device, in order to uniformly distribute the active agent in the spray liquid. Accordingly, the intermixing unit—similar to a mixing unit—may include a motor-driven mixing and/or agitator element, in order to intermix the spray liquid in the spray liquid tank. The agitator element in this case may be designed as an agitator blade or a propeller. Alternatively or in addition, the intermixing unit may also include a circulation line including, for example, a separate circulation delivery unit that includes a pump, in order to transport or conduct the spray liquid via a circulation line or a circulation line system out of the spray liquid tank and into the tank again and to thereby blend it. Instead of a separate circulation delivery unit, it is also possible to use the spray liquid delivery unit. The intermixing unit may be designed to carry out the intermixing process for a defined or predefined duration after activation, and to then automatically stop.

The delivery unit is designed to increase or adjust the active agent concentration in the spray liquid with the aid of a pump, in particular, a delivery pump and a metering pump. The delivery unit in this case includes, in particular, the liquid delivery unit with the associated pump, in particular, the delivery pump for increasing or adjusting the active agent concentration, as well as the active agent conveyer unit with the associated pump, in particular, a metering pump.

The control signal may be designed to activate the intermixing unit in order to start the intermixing process. In this case, the corresponding control signal may be output if at least the value of one piece of property information and/or the active agent concentration in the spray liquid has reached a first reference value and/or a first reference value range and/or a first reference gradient value and/or with a defined deviation therefrom, in order to activate the intermixing unit and/or the delivery unit to change the active agent concentration in the spray liquid. Alternatively or in addition, the control signal may also be designed to deactivate the intermixing unit in order terminate the intermixing process. In the process, the corresponding control signal may be output if at least the value of one piece of property information and/or of the active agent concentration in the spray liquid has reached a second reference value and/or a second reference value range and/or a second reference gradient value and/or with a defined deviation therefrom, in order to deactivate the intermixing unit and/or the delivery unit.

The information signal may be designed, to activate the display unit in such a way that a “simple” alarm signal, for example, in the form of a visual and/or acoustic and or haptic signal is output by the display unit. In this case a corresponding color signal, for example, may be output as a function of the comparison. The information signal may, however, also include the value of the property information and/or of the active agent concentration of the spray liquid, and may be designed to be displayed on the display unit. The display unit in this case may be a display, a smartphone or an arbitrary other terminal such as, for example, a tablet or a PC. The information signal may, for example, be selected from the list made up of: SMS, email, push-notification, telephone call.

Alternatively or in addition, it is possible that the information signal including the value of the property information and/or the active agent concentration of the spray liquid is output to the display unit “generally” at and/or after termination of the intermixing process, in particular, initially or only or exclusively at and/or after termination of the intermixing process, and/or during the intermixing process, in particular, during the entire duration of the intermixing process.

The example method for monitoring and/or changing the active agent concentration may be started automatically or manually. The method may be started as a function of the presence of a spray liquid in the spray liquid tank.

With the example method according to the present invention and the example spray device according to the present invention, it is now possible to prevent in a simple and cost-efficient manner an erroneous application in terms of an excessive or reduced (than that required) amount of active agent deployed on a field, and to carry out an error detection in components of the spray device. This is achieved, in particular, in that the piece of property information actually present each time at the point of deployment, i.e., the spray nozzle units, and a function of the acting agent concentration in the spray liquid (and, if necessary, the quantity of the deployed spray liquid) is ascertained, and as a function thereof an information signal is then output, in order, for example, to inform the farmer, or a control signal is output in order to carry out a remedy. This is extremely important, since the actual active agent concentration at the point of deployment, and thus at the individual spray nozzle units, may deviate from the desired or required active agent concentration for numerous reasons.

On the one hand, the initial mixing process of the spray liquid may have been carried out too briefly or the spray liquid has separated, so that no uniform concentration distribution is present in the spray liquid tank or in the lines. In this case, the time curve of the concentration at the spray nozzle units fluctuates or a false concentration is present at the spray nozzle units. As a remedy, the intermixing unit may be started manually by the farmer or automatically with the aid of the control unit, so that the spray liquid is pumped through the circulation line or intermixed via the agitator.

On the other hand, it may be monitored or checked whether the metering has been correctly carried out or whether an incorrect metering is present or even whether the active agent has been intentionally diluted with water by the dealer/supplier and the farmer has been deceived. The farmer in this case may be informed of this via a display unit in order to stop the application and/or if necessary, to correct the active agent concentration via a subsequent metering of active agent and/or water. There is also the option of detecting the quality of the active agent.

It is advantageous if a step of comparing the values of the pieces of property information and/or of the active agent concentrations in the spray liquid in the spray nozzle units with one another is provided, in order as a function thereof to output the information signal to the display unit and/or the control signal to the intermixing unit and/or to the delivery unit. In this case, it is particularly advantageous if the information signal is output to the display unit and/or the control signal is output to the intermixing unit and/or to the delivery unit, if the values of the pieces of property information and/or active agent concentrations in the spray liquid are the same and/or with a defined deviation of the values of at least two pieces of property information and/or of active agent concentrations in the spray liquid. The control signal in this case may be output with a defined deviation of the values of at least two pieces of property information and/or of active agent concentrations in order to activate the intermixing unit and/or the delivery unit and to change the active agent concentration in the spray liquid. Alternatively or in addition, the control signal may also be output if the values of the pieces of property information and/or active agent concentrations are the same, in order to deactivate the intermixing unit and/or the delivery unit. In this case, it is advantageous, if otherwise—i.e., none of the aforementioned cases occurs—after a defined duration following activation of the intermixing unit, the intermixing unit is prematurely deactivated and the delivery unit is subsequently activated. It is further advantageous if otherwise after a defined duration following activation of the intermixing unit and/or of the delivery unit, the intermixing unit and/or the delivery unit is/are prematurely deactivated and the information signal is output. With the comparison, it is possible, in particular, to detect spray nozzle units, in the through-flow area of which a spray liquid having an active agent concentration deviating from the desired active agent concentration is present. In this case, an inhomogeneity is present at the spray nozzle units among one another. As a remedy in this case, the intermixing unit may initially be activated in order to reestablish the homogeneity. If no intermixing unit is present or there is still no homogeneity present even after a defined period of time, then it is possible here either—after the output of the information signal—by the farmer him/herself or—after the output of the control signal—to raise the average active agent concentration with the aid of the delivery unit so that the active agent is present at the spray nozzle unit with lowest active agent concentration in a still effective concentration, in order to avoid a lower metering that includes the risk of resistance formation. If a (re-)calibration is unable to take place or is unsuccessful, then the application may/must be discontinued. This is also an indication of a deficiency or defect of the spray nozzle unit or of the corresponding valve, which is why the valve could be cleaned or replaced, for example.

In addition, it is advantageous if at least one value and/or reference value and/or reference value range and/or reference gradient value of the property information and/or of the active agent concentration is/are ascertained using the property information of a carrier liquid detected by an additional sensor unit. With this measure, it is possible to carry out the method more precisely, since the actual property information of the carrier liquid with no active agent is detected as a “base value” and is taken into account or is subtracted when ascertaining the aforementioned values.

It is also advantageous if at least one value and/or reference value and/or reference value range and/or reference gradient value of the property information and/or of the active agent concentration is/are ascertained using the temperature of the spray liquid and/or of the carrier liquid detected with the aid the sensor unit. In this case, it is, in particular, advantageous if the temperature is detected at the point at which the corresponding property information is also detected. Since the temperature generally has an influence on the property information (conductivity, density, etc.), it is possible by taking these factors into account when detecting or ascertaining the property information and/or the active agent concentration to carry out the method even more precisely. It is also possible as a result to also detect a demixing of the spray liquid (at the point of detection).

For detecting the property information with the aid of absorption, it is also possible, similar to the temperature, to also measure the pressure, so that for this purpose, the sensor unit may alternatively or additionally include a pressure sensor.

### BRIEF DESCRIPTION OF THE DRAWINGS

The present invention is explained by way of example in greater detail below with reference to the figures.

FIG. 1 schematically shows a representation of one exemplary embodiment of the spray device.

FIG. 2 schematically shows a representation of the example control unit.

FIG. 3 shows a flow chart of an example method for monitoring and/or modifying the active agent concentration.

In the following description of preferred exemplary embodiments of the present invention, identical or similar reference numerals are used for elements which are represented in the various figures and act similarly, a repeated description of the elements being omitted.

### DETAILED DESCRIPTION OF EXAMPLE EMBODIMENTS

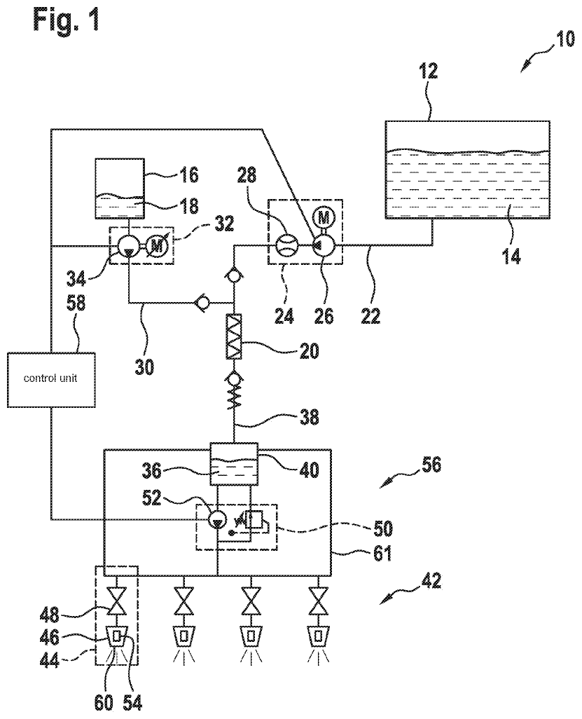

A schematic representation of a spray device is depicted in FIG. 1, which is provided in its entirety with reference numeral 10.

Spray device 10 includes a liquid tank 12 including a liquid 14 and an active agent tank 16 including an active agent 18. Liquid 14 is a carrier liquid 14 or water 14.

Spray device 10 further includes a static mixing unit 20. Static mixing unit 20 is fluidically connected to liquid tank 12 via a liquid line 22. A liquid delivery unit 24 is situated in liquid line 22 in order to be able to feed or conduct liquid 22 to static mixing unit 20. Liquid delivery unit 24 in this case includes a delivery pump 26 and a volumetric flow meter 28. Similarly, static mixing unit 20 is further connected to active agent tank 16 via an active agent line 30. In turn, an active agent delivery unit 32 is situated in active agent line 30, in order to be able to feed or conduct active agent 18 to static mixing unit 20. Acting agent delivery unit 32 in this case includes a metering pump 34.

Accordingly, active agent 18 is intermixed with carrier liquid 14 with the aid of static mixing unit 20 to form a spray liquid 36.

In order to achieve a greater metering bandwidth with a higher dosing accuracy, a spray liquid tank 40 is situated in a spray liquid line 38 downstream from static mixing unit 20. Spray liquid tank 40 in this case is designed as a buffer tank 40. Spray liquid tank 40 or buffer tank 40 is situated and designed in such a way that spray liquid 36 is poured from static mixing unit 20 into spray liquid tank 40, in order to then be conducted from spray liquid tank 40 to a nozzle system 42 including spray nozzle units 44. Each of spray nozzle units 44 includes a spray nozzle 46 for deploying spray liquid 36 and a valve 48 for controlling or regulating the deployed quantity of spray liquid.

To adjust the spray pressure at the spray nozzle units 44, spray device 10 further includes a spray liquid delivery unit 50, which is designed to feed spray liquid 36 from spray liquid tank 40 under pressure or under a defined pressure to nozzle system 42, or spray nozzle units 44. Spray liquid delivery unit 50 in this case include a constant pressure source including a pump 52.

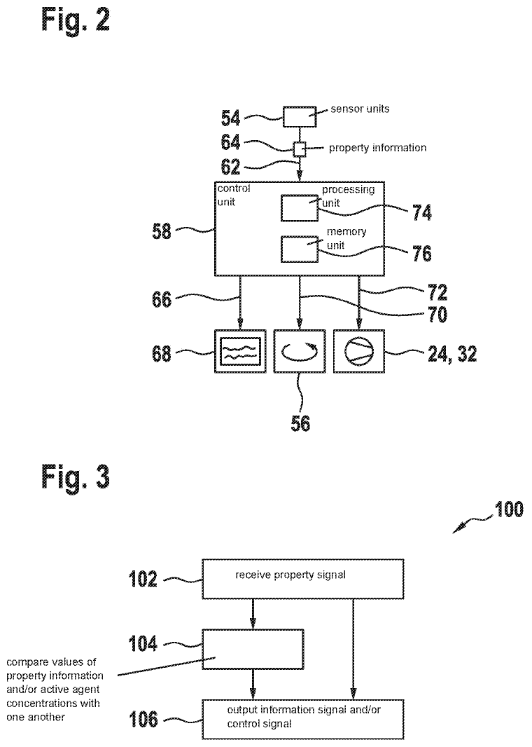

In order to then be able to monitor and/or modify the active agent concentration in spray liquid 36 in spray nozzle devices 44, spray device 10 further includes sensor units 54, an intermixing unit 56 for intermixing spray liquid 36, and a control unit 58 for controlling intermixing unit 56. One sensor unit 58 each is situated in one through-flow area 56 each of spray nozzle units 44 or spray nozzle 46. Sensor units 54 are each designed to detect a piece of property information of spray liquid 36 in through-flow area 60 of the corresponding spray nozzle unit, an active agent concentration being ascertainable in spray liquid 36 using the property information. Intermixing unit 56 includes a circulation line 61, in order to be able to conduct, or to pump with the aid of spray liquid delivery unit 50, spray liquid 36 back into spray liquid tank 40. In FIG. 2, it is subsequently explained how the monitoring and/or modifying of the active agent concentration takes place with the aid of control unit 58.

As is more readily apparent from FIG. 2, control unit 58 is configured to receive property signals 62 including one piece of property information 64 of spray liquid 36 detected with the aid of sensor units 54 of spray device 10 in corresponding through-flow area 60 of spray nozzle units 44. The pieces of property information 64 in this case include in each case an electrical conductivity and a temperature of spray liquid 36 and a volume flow of deployed spray liquid 36. Accordingly, sensor units 54 each include a sensor for detecting the electrical conductivity and a sensor for detecting the temperature as well as a through-flow sensor or volumetric flow meter for detecting the quantity of deployed spray liquid. Control unit 58 is also configured to output an information signal 66 to a display unit 68 and/or a control signal 70 to intermixing unit 56 and/or a control signal 72 to delivery unit 24, 32 as a function of at least one of the pieces of property information 64 of spray liquid 36 and/or of an active agent concentration in spray liquid 36 ascertained using property information 64, in order to monitor and/or to modify the active agent concentration in spray liquid 36.

Control unit 58 in this case is configured to compare the values of pieces of property information 64 and/or the active agent concentrations in spray liquid 36 in spray nozzle units 44 with one another with the aid of a processing unit 74, in order as a function thereof to output information signal 66 to display unit 38 and/or control signal 70, 72 to intermixing unit 56 and/or to delivery unit 24, 32. Processing unit 74 is further designed to ascertain an active agent concentration in spray liquid 36 using pieces of property information 64. On the one hand, control signal 70, 72 is output with a defined deviation of the values of at least two pieces of property information 64 and/or active agent concentrations. In this case, control signal 70, 72 is designed to activate intermixing unit 54 and/or delivery unit 24, 32, in order to modify or increase the active agent concentration in spray liquid 36. On the other hand, control signal 70, 72 is then output if the values of the pieces of property information 64 and/or active agent concentrations are the same. Control signal 70, 72 in this case is designed to deactivate intermixing unit 54 and/or delivery unit 24, 32. Control unit 58 further includes a memory unit 76 for storing pieces of property information 64 and the ascertained values.

FIG. 3 shows a flow chart of an example method 100 for monitoring and/or modifying an active agent concentration in a spray liquid 36 of a spray device 10 including a plurality of spray nozzle units 44 for deploying spray liquid 36, in particular, for agricultural purposes. Method 100 includes a step 102 of receiving one property signal 63 each that includes a piece of property information 64 of spray liquid 36 ascertained with the aid of a sensor unit 54 of spray device 10 in a through-flow area 60 of one of spray nozzle units 44 each, an active agent concentration in spray liquid 36 being ascertainable using property information 64. Finally, method 100 includes a step 106 of outputting an information signal 66 to a display unit 68 and/or a control signal 70, 72 to an intermixing unit 56 and/or to a delivery unit 24, 32 of spray device 10 as a function of received property information 64 of spray liquid 36 and/or of an active agent concentration in spray liquid 36 ascertained using property information 64, in order to monitor and/or to modify the active agent concentration in spray liquid 36 in spray nozzle unit 44. Method 100 optionally also includes a step 104 of comparing the values of pieces of property information 64 and/or the active agent concentrations in spray liquid 36 in spray nozzle units 44 with one another, in order as a function thereof to output information signal 66 to display unit 68 and/or control signal 70, 72 to intermixing unit 56 and/or to delivery unit 24, 32.

If an exemplary embodiment includes an “and/or” linkage between a first feature and a second feature, this is to be read in the sense that the exemplary embodiment according to one specific embodiment includes both the first feature and the second feature, and according to another specific embodiment, either only the first feature or only the second feature.

1-20. (canceled)

21. A method for monitoring and/or modifying an active agent concentration in a spray liquid of a spray device, the spray device including a plurality of spray nozzle units for deploying the spray liquid for agricultural purposes, the method comprising the following steps:
receiving property signals, each of which includes a piece of property information of the spray liquid detected using a respective sensor unit situated in a through-flow area of a different respective one of the spray nozzle units of the spray device, an active agent concentration in the spray liquid being ascertainable using the piece of property information; and
outputting (i) an information signal to a display unit, and/or (ii) a control signal to an intermixing unit of the spray device and/or a delivery unit of the spray device, the outputting of the information signal and/or the control signal being a function of (i) the received pieces of property information of the spray liquid, and/or (ii) an active agent concentration in the spray liquid ascertained using the piece of property information, in order to monitor and/or to modify the active agent concentration in the spray liquid in the spray nozzle units.

22. The method as recited in claim 21, further comprising the following step:
comparing values of the pieces of property information and/or of the active agent concentrations in the spray liquid in the spray nozzle units with one another, wherein the information signal is output, as a function of the comparison, to the display unit and/or the control signal is output, as a function of the comparison, to the intermixing unit and/or to the delivery unit.

23. The method as recited in claim 21, further comprising the following step:
comparing values of the pieces of property information and/or of the active agent concentrations in the spray liquid with a predefinable reference value and/or a predefinable reference value range of the property information and/or of the active agent concentration, wherein the information signal is output, as a function of the comparison, to the display unit, and/or the control signal is output, as a function of the comparison, to the intermixing unit and/or to the delivery unit.

24. The method as recited in claim 21, further comprising the following step:
comparing reference gradient values of the pieces of property information and/or of the active agent concentrations in the spray liquid, with a predefinable reference gradient of the property information and/or of the active agent concentration, wherein the information signal is output, as function of the comparison, to the display unit, and/or the control signal is output, as a function of the comparison, to the intermixing unit and/or to the delivery unit.

25. The method as recited in claim 22, wherein the values of the pieces of the property information and/or of the active agent concentration, are ascertained using property information of a carrier liquid of the spray liquid detected using an additional sensor unit.

26. The method as recited in claim 22, wherein the values of the pieces of the property information and/or of the active agent concentration are ascertained using a temperature of the spray liquid and/or of the carrier liquid detected using the sensor units.

27. The method as recited in claim 22, wherein (i) the information signal is output to the display unit, and/or (ii) the control signal is output to the intermixing unit and/or to the delivery unit, if the values of the pieces of property information and/or of the active agent concentrations in the spray liquid are the same, and/or with a defined deviation of the values of at least two pieces of property information and/or active agent concentrations in the spray liquid.

28. The method as recited in claim 22, wherein (i) the information signal is output to the display unit, and/or (ii) the control signal is output to the intermixing unit and/or to the delivery unit, if at least the value of one of the pieces of property information and/or of an active agent concentration in the spray liquid has reached a reference value and/or a reference value range and/or a reference gradient value and/or with a defined deviation.

29. The method as recited in claim 22, wherein the control signal is output:
(i) with a defined deviation of the values at least of two pieces of property information and/or active agent concentrations, and/or
(ii) if at least the value of one piece of property information and/or the active agent concentration in the spray liquid has reached a first reference value and/or a first reference value range and/or a first reference gradient value and/or with a defined deviation,
to activate the intermixing unit and/or the delivery unit and to modify the acting agent concentration in the spray liquid.

30. The method as recited in claim 29, wherein the control signal is output if:
as a first condition, the values of the pieces of property information and/or of the acting agent concentrations are the same, and/or
as a second condition, at least the value of one of the pieces of property information and/or of the acting agent concentration in the spray liquid has reached a second reference value and/or a second reference value range and/or a second reference gradient value and/or with a defined deviation,
to deactivate the intermixing unit and/or the delivery unit.

31. The method as recited in claim 30, wherein if neither the first condition nor the second condition occurs, the intermixing unit is prematurely deactivated and the delivery unit is subsequently activated after a defined duration following activation of the intermixing unit.

32. The method as recited in claim 30, wherein if neither the first condition nor the second condition occurs, the intermixing unit and/or the delivery unit is prematurely deactivated and the information signal is output after a defined duration following activation of the intermixing unit and/or of the delivery unit.

33. The method as recited in claim 20, wherein (i) the intermixing unit is configured to intermix the spray liquid with the aid of a circulation line and/or of an agitator element situated in a spray liquid tank of the spray device, to uniformly distribute the active agent in the spray liquid, and/or (ii) the delivery unit is configured to increase the active agent concentration in the spray liquid using a delivery pump and a metering pump.

34. The method as recited in claim 20, wherein the information signal includes values of the pieces of property information and/or of the active agent concentrations in the spray liquid, to be displayed on the display unit.

35. The method as recited in claim 20, wherein the detected pieces of property information includes one or more of the following: electrical property, electrical conductivity or permittivity, visual property, absorption property, emission property, fluorescence, sound velocity.

36. The method as recited in claim 35, wherein the detected pieces of property information further includes a volume flow of the spray liquid so that a quantity of the deployed spray liquid is ascertainable.

37. A control unit configured to monitor and/or modify an active agent concentration in a spray liquid of a spray device, the spray device including a plurality of spray nozzle units for deploying the spray liquid for agricultural purposes, the control unit configured to:
receive property signals, each of which includes a piece of property information of the spray liquid detected using a respective sensor unit situated in a through-flow area of a different respective one of the spray nozzle units of the spray device, an active agent concentration in the spray liquid being ascertainable using the piece of property information; and
output (i) an information signal to a display unit, and/or (ii) a control signal to an intermixing unit of the spray device and/or a delivery unit of the spray device, the outputting of the information signal and/or the control signal being a function of (i) the received pieces of property information of the spray liquid, and/or (ii) an active agent concentration in the spray liquid ascertained using the piece of property information, in order to monitor and/or to modify the active agent concentration in the spray liquid in the spray nozzle units.

38. A spray device including a plurality of spray nozzle units for deploying a spray liquid that includes an active agent for agricultural purposes, the spray device comprising:
(i) an intermixing unit configured to intermix the spray liquid, and/or (ii) a delivery unit configured to adjust an active agent concentration in the spray liquid;
sensor units, each of the respective sensor units configured to detect, in each case a piece of property information of the spray liquid in a through-flow area of a different one of the spray nozzle units, an active agent concentration in the spray liquid being ascertainable using the piece of property information; and
a control unit configured to monitor and/or for modify the active agent concentration in the spray nozzle unit, the control unit configured to
receive property signals, each of which includes one of the pieces of the property information; and
output (i) an information signal to a display unit, and/or (ii) a control signal to the intermixing unit and/or the delivery unit, the outputting of the information signal and/or the control signal being a function of (i) the received pieces of property information of the spray liquid, and/or (ii) an active agent concentration in the spray liquid ascertained using the piece of property information, in order to monitor and/or to modify the active agent concentration in the spray liquid in the spray nozzle units.

39. A non-transitory machine-readable memory medium on which is stored a computer program for monitoring and/or modifying an active agent concentration in a spray liquid of a spray device, the spray device including a plurality of spray nozzle units for deploying the spray liquid for agricultural purposes, the computer program, when executed by a computer, causing the computer to perform the following steps:
receiving property signals, each of which includes a piece of property information of the spray liquid detected using a respective sensor unit situated in a through-flow area of a different respective one of the spray nozzle units of the spray device, an active agent concentration in the spray liquid being ascertainable using the piece of property information; and
outputting (i) an information signal to a display unit, and/or (ii) a control signal to an intermixing unit of the spray device and/or a delivery unit of the spray device, the outputting of the information signal and/or the control signal being a function of (i) the received pieces of property information of the spray liquid, and/or (ii) an active agent concentration in the spray liquid ascertained using the piece of property information, in order to monitor and/or to modify the active agent concentration in the spray liquid in the spray nozzle units.
